(19) United States
(12) Patent Application Publication
(10) Pub. No.: US 2020/0271977 A1
(43) Pub. Date: Aug. 27, 2020

(54) LIQUID CRYSTAL DISPLAY SUBSTRATE AND DISPLAY DEVICE

(71) Applicant: BOE Technology Group Co., Ltd., Beijing (CN)

(72) Inventors: Liqiang Chen, Beijing (CN); Paoming Tsai, Beijing (CN); Weifeng Zhou, Beijing (CN)

(21) Appl. No.: 16/643,912

(22) PCT Filed: May 17, 2019
(86) PCT No.: PCT/CN2019/087325

§ 371 Date: Mar. 3, 2020

(30) Foreign Application Priority Data
May 21, 2018 (CN) 201810489237.9

(51) Int. Cl. G02F 1/1345

(52) U.S. Cl. CPC G02F 1/13452; G02F 1/13458

(57) ABSTRACT

The present disclosure discloses a liquid crystal display substrate and device, belonging to the field of display technology. The liquid crystal display substrate includes a plurality of pixel units, a driving circuit, a conductive layer and a flexible substrate. The pixel units are connected with the driving circuit by means of the conductive layer, the driving circuit is configured to drive the plurality of pixel units to display images; the flexible substrate is in a bent state; and the conductive layer is located outside a bending position of the flexible substrate, and the driving circuit and the plurality of pixel units are respectively located on two opposite sides of the flexible substrate in the bent state.

This application is a 371 of PCT Application No. PCT/CN2019/087325, filed May 17, 2019, which claims priority to Chinese Patent Application No. 201810489237.9, filed May 21, 2018 and entitled “LIQUID CRYSTAL DISPLAY SUBSTRATE AND DISPLAY DEVICE”, the entire contents of which are incorporated herein by reference.

### TECHNICAL FIELD

The present disclosure relates to the field of display technology, and more particularly to a liquid crystal display substrate and a display device.

### BACKGROUND

Generally, a liquid crystal display (LCD) has a display region and a soldering region. A plurality of pixel units are disposed in the display region. Driving circuits, such as a driving integrated circuit (IC) and a flexible printed circuit (FPC) board, are disposed in the soldering region. The driving circuit is electrically connected with the plurality of pixel units for driving the pixel units to display images. The plurality of pixel units and the driving circuit are manufactured on a glass substrate.

### SUMMARY

The present disclosure provides a liquid crystal display substrate and a display device. The technical solutions are as follows:

In an aspect, a liquid crystal display substrate is provided. The liquid crystal display substrate comprises: a plurality of pixel units, a driving circuit, a conductive layer and a flexible substrate, wherein the pixel units are connected with the driving circuit by means of the conductive layer, and the driving circuit is configured to drive the plurality of pixel units to display images; and

the flexible substrate is in a bent state, the conductive layer is located outside a bending position of the flexible substrate, and the driving circuit and the plurality of pixel units are respectively located on two opposite sides of the flexible substrate in the bent state.

Optionally, the conductive layer in a bending region has at least one through hole, a bottom of the through hole is in contact with the flexible substrate, and both the flexible substrate and the conductive layer are bent in the bending region.

Optionally, an extending direction of the through hole is perpendicular to a surface, which is in contact with a bottom of the through hole, of the flexible substrate.

Optionally, a cross section of the through hole is of a circle shape, a diamond shape, or a strip shape, and a direction of the cross section crosses the extending direction of the through hole.

Optionally, the liquid crystal display substrate further comprises: a first buffer layer, wherein the first buffer layer is located on a target surface of a side, which is away from the conductive layer, of the flexible substrate, and covers a portion, which is located in the bending region, of the target surface, and the flexible substrate is bent in the bending region.

Optionally, a cross section of a contact surface of the first buffer layer and the flexible substrate in the bending region in a direction perpendicular to the contact surface is of an arc shape.

Optionally, the liquid crystal display substrate further comprises: a supporting structure, wherein the supporting structure is located on the target surface, and an orthographic projection of the supporting structure on the flexible substrate in a first direction covers an orthographic projection of the plurality of pixel units on the flexible substrate in the first direction; and

the first buffer layer covers a surface, which faces the bending region, of the supporting structure.

Optionally, the supporting structure comprises a first base substrate.

Optionally, the first buffer layer is made of metal, foam, resin or acrylic.

Optionally, the liquid crystal display substrate further comprises: a second buffer layer located on a side, which is away from the flexible substrate, of the conductive layer, wherein an orthographic projection of the second buffer layer on the flexible substrate covers an orthographic projection of the conductive layer on the flexible substrate.

Optionally, ductility of a material of the second buffer layer is better than that of a material of the conductive layer.

Optionally, the second buffer layer is made of ultraviolet curing adhesive, acrylic or epoxy resin.

Optionally, the liquid crystal display substrate further comprises: a third buffer layer, wherein the third buffer layer is located inside the bending position of the flexible substrate in the bent state, the third buffer layer is configured to fix a relative position between the flexible substrate in a soldering region and the flexible substrate in a display region; and

the driving circuit is formed on a surface of the flexible substrate in the soldering region, and the plurality of pixel units are formed on a surface of the flexible substrate in the display region.

Optionally, the liquid crystal display substrate further comprises: a supporting structure, wherein a first side of the supporting structure is fixedly connected with a target surface of the flexible substrate in the display region, a second side of the supporting structure is fixedly connected with a first side of the third buffer layer, and a second side of the third buffer layer is fixedly connected with a target surface of;

wherein an orthographic projection of the supporting structure on the flexible substrate along a first direction covers an orthographic projection of the plurality of pixel units on the flexible substrate along the first direction, the second side of the supporting structure is opposite to the first side of the supporting structure, the second side of the third buffer layer is opposite to the first side of the third buffer layer, and the target surface is a surface on a side, which is away from the conductive layer, of the flexible substrate.

Optionally, the liquid crystal display substrate further comprises a first buffer layer, wherein the third buffer layer and the first buffer layer are of an integral structure;

wherein the first buffer layer is located on a target surface of a side, away from the conductive layer, of the flexible substrate and covers a portion of the target surface in a bending region, and the flexible substrate is bent in the bending region.

Optionally, the third buffer layer is made of foam.

Optionally, the liquid crystal display substrate further comprises: a second base substrate, wherein an orthographic projection of the second base substrate on the flexible substrate along a second direction covers an orthographic projection of the driving circuit on the flexible substrate along the second direction.

In another aspect, a liquid crystal display device is provided. The liquid crystal display device comprises a liquid crystal display substrate, wherein the liquid crystal display substrate comprises: a plurality of pixel units, a driving circuit, a conductive layer and a flexible substrate, wherein the pixel units are connected with the driving circuit by means of the conductive layer, and the driving circuit is configured to drive the plurality of pixel units to display images; and

the flexible substrate is in a bent state, the conductive layer is outside a bending position of the flexible substrate, and the driving circuit and the plurality of pixel units are respectively located on two opposite sides of the flexible substrate in the bent state.

Optionally, a plurality of pixel units of the liquid crystal display substrate comprises liquid crystal cells; and the liquid crystal display device further comprises a middle frame and a backlight source, wherein the backlight source and the middle frame are in a gap formed by the flexible substrate in a soldering region and the flexible substrate in a display region, and the middle frame is on a side, away from the plurality of pixel units, of the backlight source, and the liquid crystal cells and the backlight source are fixedly connected with the middle frame; the driving circuit is formed on a surface of the flexible substrate in the soldering region, and the plurality of pixel units is formed on a surface of the flexible substrate in the display region.

Optionally, the liquid crystal display substrate further comprises: a first buffer layer, wherein the first buffer layer is on a target surface of a side, which is away from the conductive layer, of the flexible substrate and covers a portion of the target surface in a bending region, the flexible substrate is bent in the bending region; and the middle frame and a first buffer layer in the liquid crystal display substrate are of an integral structure.

### BRIEF DESCRIPTION OF THE DRAWINGS

In order to describe the technical solutions in the embodiments of the present disclosure more clearly, the following briefly introduces the accompanying drawings required for describing the embodiments. Apparently, the accompanying drawings in the following description show merely some embodiments of the present disclosure, and a person of ordinary skill in the art may also derive other drawings from these accompanying drawings without creative efforts.

FIG. 1 is a schematic diagram illustrating a structure of a liquid crystal display substrate according to an embodiment of the present disclosure;

FIG. 2 is a schematic diagram illustrating a structure of another liquid crystal display substrate according to an embodiment of the present disclosure;

FIG. 3 is a schematic diagram illustrating a structure of further liquid crystal display substrate according to an embodiment of the present disclosure;

FIG. 4 is a schematic diagram illustrating a structure of still another liquid crystal display substrate according to an embodiment of the present disclosure;

FIG. 5 is a schematic diagram illustrating a structure of yet another liquid crystal display substrate according to an embodiment of the present disclosure;

FIG. 6 is a schematic top view illustrating a conductive layer according to an embodiment of the present disclosure;

FIG. 7 is a schematic diagram illustrating a structure of still yet another liquid crystal display substrate according to an embodiment of the present disclosure; and

FIG. 8 is a schematic diagram illustrating a structure of a liquid crystal display device according to an embodiment of the present disclosure.

### DETAILED DESCRIPTION

Embodiments of the present disclosure will be described in further detail with reference to the accompanying drawings, to present the principles and advantages of the present disclosure more clearly.

As known to the inventors, pixel units, a driving circuit and the like are all formed on a glass substrate. Moreover, in order to reduce the border of a LCD, structures, such as a soldering pad, are usually manufactured on a side of the glass substrate in a printing manner, and then electronic components are soldered on the soldering pad, to a soldering region including the driving circuit.

However, as the usable area on the side of the glass substrate is small, it is difficult to manufacture the driving circuit on the glass substrate, resulting in a low yield rate of manufacturing the driving circuit on the side of the glass substrate.

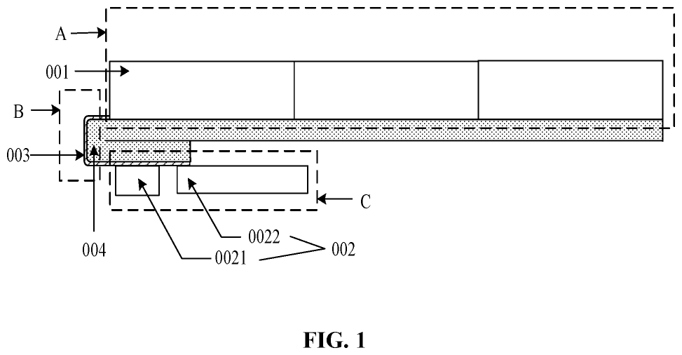

An embodiment of the present disclosure provides a liquid crystal display substrate. With reference to FIG. 1, the liquid crystal display substrate includes a plurality of pixel units 001, a driving circuit 002, a conductive layer 003 and a flexible substrate 004. Moreover, the liquid crystal display substrate has a display region A, a bending region B and a soldering region C. The plurality of pixel units 001 are disposed in the display region A. The driving circuit 002 is disposed in the soldering region C. The conductive layer 003 is disposed in the bending region B. Both the flexible substrate 004 and the conductive layer 003 are bent in the bending region B. The pixel units 001 are connected with the driving circuit 002 by means of the conductive layer 003. The driving circuit 002 is configured to drive the plurality of pixel units 001 to display images.

Moreover, with reference again to FIG. 1, the flexible substrate 004 is in a bent state. The conductive layer 003 is located outside a bending position of the flexible substrate (004). The driving circuit 002 and the plurality of pixel units 001 are respectively located on two opposite sides of the flexible substrate 004 in the bent state.

In the two opposite sides of the flexible substrate 004 in the bent state, the side in which the plurality of pixel units 001 are located may be referred to as a display side of the liquid crystal display substrate, and the side in which the driving circuit 002 is located may be referred to as a non-display side of the liquid crystal display substrate.

In summary, the flexible substrate in the liquid crystal display substrate provided in the embodiments of the present disclosure is in the bent state, such that the driving circuit and the plurality of pixel units are respectively located on two opposite sides of the flexible substrate in the bent state. Thus, the area occupied by the non-display region in which the driving circuit is located on the display side of the liquid crystal display substrate can be reduced, which helps implementation of a narrow border. Compared with the related art, the driving circuit does not need to be manufactured on the side of the glass substrate, such that the driving circuit can be manufactured in a greater area, which reduces the difficulty of manufacturing the driving circuit, and increases the yield rate of the driving circuit.

The flexible substrate 004 may be made of a bending-resistant material such as polyimide, polyamide, polyethylene terephthalate (PET), polyethylene naphthalate, polyvinyl alcohol (PVA), polyetheretherketone or polycarbonate.

Optionally, the liquid crystal display substrate may further include a supporting structure. The supporting structure is on the target surface of the side, away from the conductive layer 003, of the flexible substrate 004, and an orthographic projection of the supporting structure on the flexible substrate 004 in a first direction may cover an orthographic projection of the plurality of pixel units 001 on the flexible substrate 004 in the first direction, such that the supporting structure provides a supporting force to the plurality of pixel units 001 and the flexible substrate 004 in the display region A. In addition, the supporting structure can increase the distance between the flexible substrate in the display region and the flexible substrate in the soldering region, such that the flexible substrate in the soldering region can be bent in a small arc, which can reduce the probability of breakage of the flexible substrate caused by being. Here, the first direction may be perpendicular to a surface, in the display region A, of the flexible substrate 004.

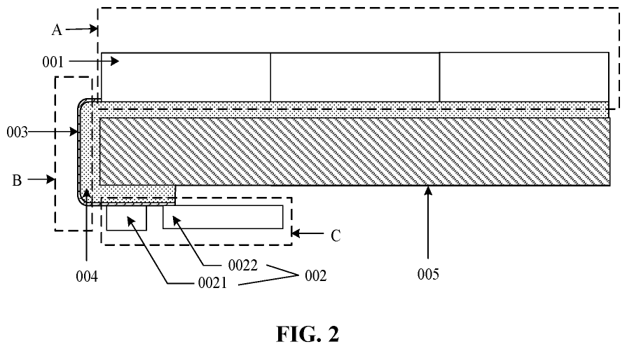

In an implementation, as illustrated in FIG. 2, the supporting structure may include a first base substrate 005. The first base substrate 005 may be a transparent substrate, which may be a substrate made of a material with a certain hardness, such as glass, quartz, and transparent resin.

For example, with reference again to FIG. 2, the liquid crystal display substrate may further include a first base substrate 005. The first base substrate 005 is on the target surface of the flexible substrate 004. An orthographic projection of the first base substrate 005 on the flexible substrate 004 in the first direction covers an orthographic projection of the plurality of pixel units 001 on the flexible substrate 004 in the first direction. The flexible substrate 004 and the plurality of pixel units 001 are sequentially laminated on the first base substrate 005. The first base substrate 005 is configured to support the plurality of pixel units 001 and the flexible substrate 004 in the display region A.

It should be noted that the supporting structure may also have other implementations. For example, the supporting structure may be a film layer with a hardness value greater than a reference hardness value.

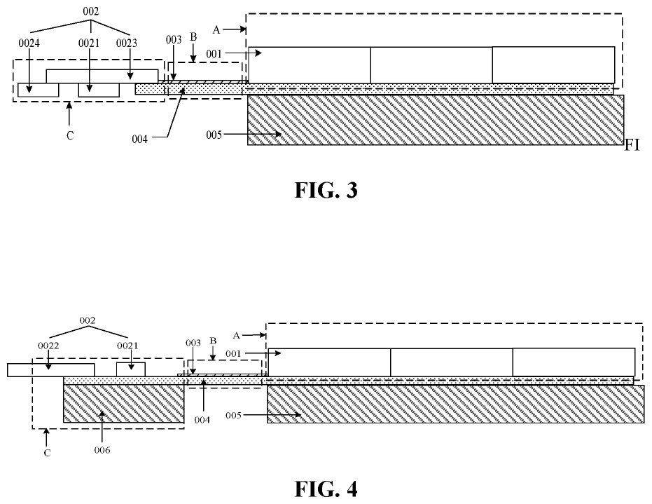

Moreover, each pixel unit 001 may include a thin film transistor (TFT), a pixel electrode, a liquid crystal cell, a common electrode, a color film layer and the like. The liquid crystal cell may be internally provided with an alignment layer, a spacer, a liquid crystal layer, sealant and the like. As shown in FIG. 1 and FIG. 2, driving circuits 002 such as an IC 0021 and a FPC 0022 may be disposed in the soldering region C. The IC 0021 is configured to provide the pixel units 001 with a driving voltage required for displaying an image, the FPC 0022 is configured to provide the IC 0021 with an external circuit (such as a circuit composed of components such as a capacitor and an inductor) required for driving, and the IC 0021 and the FPC 0022 may be internally provided with a TFT, a conductive metal line, and the like. And/or a chip on film (COF), a print circuit board (PCB), and the like may further be disposed in the soldering region C FIG. 3 is a schematic diagram illustrating the soldering region C provided with a COF 0023, an IC 0021 and a PCB 0024. By bending the flexible substrate 004 to the non-display side of the liquid crystal display substrate, the area occupied by the driving circuit on the display side of the liquid crystal display substrate can be reduced.

Optionally, FIG. 4 is a schematic diagram illustrating a flexible substrate 004 in a non-bent state. As shown in FIG. 4, the liquid crystal display substrate may further include a second base substrate 006. An orthographic projection of the second base substrate 006 on the flexible substrate 004 in a second direction covers an orthographic projection of the driving circuit 002 on the flexible substrate 004 in the second direction. The second base substrate 006 is configured to support the flexible substrate 004 in the soldering region C and the driving circuit 002, such that the flexible substrate 004 and the driving circuit 002 keep flat in the bending process, so as to reduce the defects, such as line breakage, of the driving circuit 002 in the bending process. Here, the second direction may be perpendicular to the surface of the flexible substrate 004 in the soldering region C.

Optionally, the second base substrate 006 may be a transparent substrate, which may be a substrate made of a material with a certain hardness, such as glass, quartz, transparent resin, or metal (for example, stainless steel). Alternatively, the second base substrate 006 may be made of a bending-resistant material, such as polyimide, polyamide, PET, polyethylene naphthalate, PVA, polyetheretherketone or polycarbonate.

It should be noted that both the first base substrate 005 and the second base substrate 006 may be a part of the base substrate used in manufacturing the liquid crystal display substrate. In the manufacturing process, the flexible substrate 004, the pixel units 001, the driving circuit 002, and the like may be sequentially formed on the base substrate, and the base substrate in the bending region B is removed through laser stripping after the manufacture, to obtain the first base substrate 005 and the second base substrate 006. Alternatively, the base substrate in the bending region B and in the soldering region C is removed, to obtain the first base substrate 005. Alternatively, the base substrate in the bending region B and in the display region A is removed, to obtain the second base substrate 006.

Optionally, the liquid crystal display substrate may further include a first buffer layer. The first buffer layer is located on a target surface of a side, which is away from the conductive layer 003, of the flexible substrate 004, and covers a portion, which is located in the bending region, of the target surface. The first buffer layer is configured to provide a buffering force to the flexible substrate 004 located in the bending region B, so that the conductive layer 003 located in the bending region B is prevented from being broken due to an excessive bending angle, and thus the yield rate of the liquid crystal display substrate is increased.

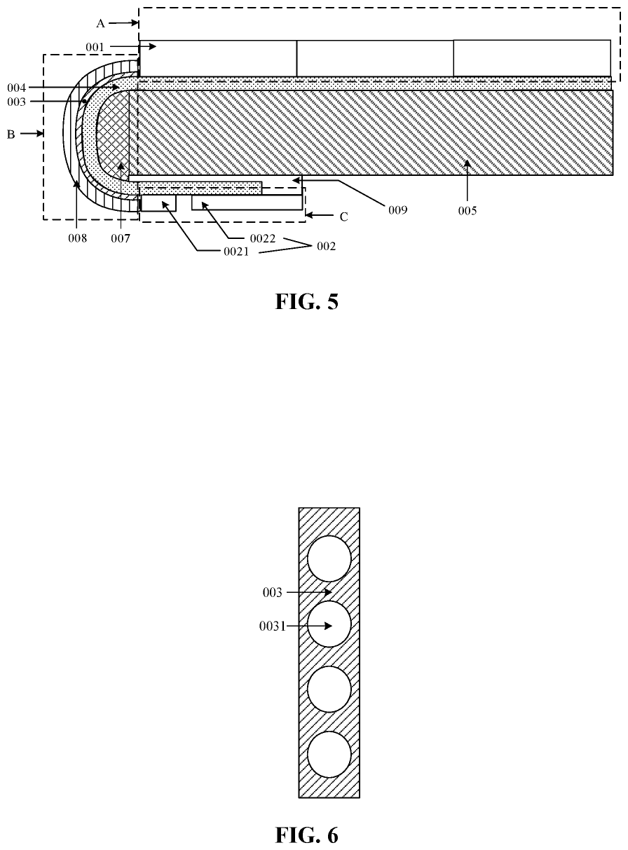

In an implementable manner of the first buffer layer, when the liquid crystal display substrate includes a supporting structure, the first buffer layer may cover a portion of the target surface, which is located in the bending region B, of the flexible substrate 004, and may further cover a surface, which faces the bending region B, of the supporting structure. For example, with reference to FIG. 5, when the liquid crystal display substrate includes a first base substrate 005, the first buffer layer 007 may cover the surface, which faces the bending region B, of the first base substrate 005, that is, the first buffer layer 007 is located in a gap enclosed by the first base substrate 005 and the flexible substrate 004.

In another implementable manner of the first buffer layer, when the liquid crystal display substrate does not include a supporting structure, the first buffer layer may cover a portion of the target surface, which is located in a bending region B, of the flexible substrate 004, and may further cover a portion of the target surface, which is located in the display region A, of the flexible substrate 004, to provide a buffering force simultaneously to the flexible substrate 004 in the display region A and the flexible substrate 004 in the bending region B.

Further, with reference again to FIG. 5, a cross section of a contact surface of the first buffer layer 007 and the flexible substrate 004 in the bending region B in a direction perpendicular to the contact surface may be of an arc shape, so that the flexible substrate 004 in the bending region B can be bent along the arc. Thus, the bending force subjected by the flexible substrate 004 in the bending region B and the conductive layer 003 due to bending can be uniformly distributed along the arc. Therefore, the bending force subjected by the flexible substrate 004 and the conductive layer 003 is reduced, and the conductive layer 003 in the bending region B is prevented from being broken due to an excessive bending angle. Alternatively, the cross section of the contact surface in the direction perpendicular to the contact surface may be in other shapes, as long as the bending force subjected by the flexible substrate 004 and the conductive layer 003 in the bending process can be reduced. For example, the other shapes may include a wave shape or the like, which is not specifically limited in the embodiments of the present disclosure.

Here, in order to ensure that the first buffer layer 007 can provide a good buffering effect to the flexible substrate 004 and the conductive layer 003, the first buffer layer 007 may be made of a material such as metal, foam, resin (for example, epoxy resin) or acrylic.

Further, with reference to FIG. 5, the liquid crystal display substrate may further include a second buffer layer 008 on the side, which is away from the flexible substrate 004, of the conductive layer 003. An orthographic projection of the second buffer layer 008 on the flexible substrate 004 may cover an orthographic projection of the conductive layer 003 on the flexible substrate 004. That is, the second buffer layer 008 may cover the side, which is away from the flexible substrate 004, of the conductive layer 003, so as to provide a buffering force to the conductive layer 003 and prevent the conductive layer 003 from being broken due to an excessive bending angle, thereby increasing the yield rate of the liquid crystal display substrate.

Moreover, in order to ensure that the second buffer layer 008 can provide sufficient buffering force to the conductive layer 003, the ductility of the material of the second buffer layer 008 may be better than that of the material of the conductive layer 003. For example, the second buffer layer 008 may be made of glue which blocks water and oxygen, such as ultraviolet curing adhesive, acrylic or epoxy resin. Meanwhile, by adjusting the thickness of the second buffer layer 008, the conductive layer 003 may be enabled to be located in a stress neutral layer in the bending region B, so that the bending force subjected by the conductive layer 003 is further reduced, and the conductive layer 003 is prevented from being broken during bending. Here, the stress subjected by the stress neutral layer is approximately equal to zero.

Optionally, with reference again to FIG. 5, the liquid crystal display substrate may further include a third buffer layer 009, which is located inside a bending position of the flexible substrate 004 in the bent state. The third buffer layer 009 is configured to fix a relative position between the flexible substrate 004 in the soldering region and the flexible substrate 004 in the display region. For example, the third buffer layer 009 may be a film layer with a strong adhesion force on the surface. In this case, one side of the third buffer layer 009 may be attached to the surface of the flexible substrate 004 in the soldering region C, and the other side of the third buffer layer 009 may be attached to the surface of the first base substrate 005, so that the distance between the flexible substrate 004 in the soldering region C and the flexible substrate 004 in the display region keeps equal to the thickness of the first base substrate 005.

In another possible implementation, when the liquid crystal display substrate further includes a supporting structure, a first side of the supporting structure may be fixedly connected with a target surface of the flexible substrate 004 in the display region, a second side of the supporting structure may be fixedly connected with a first side of the third buffer layer 009, and a second side of the third buffer layer 009 may be fixedly connected with a target surface of the flexible substrate 004 in the soldering region. Here, the second side of the supporting structure is to the first side of the supporting structure, and the second side of the third buffer layer is opposite to the first side of the third buffer layer.

Optionally, the fixe connection may be implemented as being pasted and the like. In addition, FIG. 5 illustrates that the third buffer layer 009 is at the relative position between the flexible substrate 004 in the soldering region and the flexible substrate 004 in the display region when the supporting structure include the first base substrate 005.

In addition, when the first buffer layer 007 and the third buffer layer 009 are made of the same material, for example, when the first buffer layer 007 and the third buffer layer 009 are both made of foam, the first buffer layer 007 and the third buffer layer 009 may be of an integral structure, so that the manufacturing process of the liquid crystal display substrate is simplified.

Optionally, with reference to FIG. 6, the conductive layer 003 may further be internally provided with at least one through hole 0031, and the bottom of the through hole 0031 is in contact with the flexible substrate 004. For example, an extending direction of the through hole 0031 may be perpendicular to a surface, which is in contact with the bottom of the through hole 0031, of the flexible substrate 004. When the through hole 0031 is disposed in the conductive layer 003, an acting force required for bending the conductive layer 003 in the bending region B can be reduced. Accordingly, the bending force subjected by the conductive layer 003 can be reduced, and thus the conductive layer 003 is prevented from being broken during bending.

Here, the cross section of the through hole 0031 may be of a circle shape (as shown in FIG. 6), a diamond shape or a strip shape, and the extending direction of the strip shape may be parallel to the extending direction of the conductive layer 003. Optionally, the direction of the cross section may cross the extending direction of the through hole. For example, the direction of the cross section is perpendicular to the extending direction of the through hole 0031.

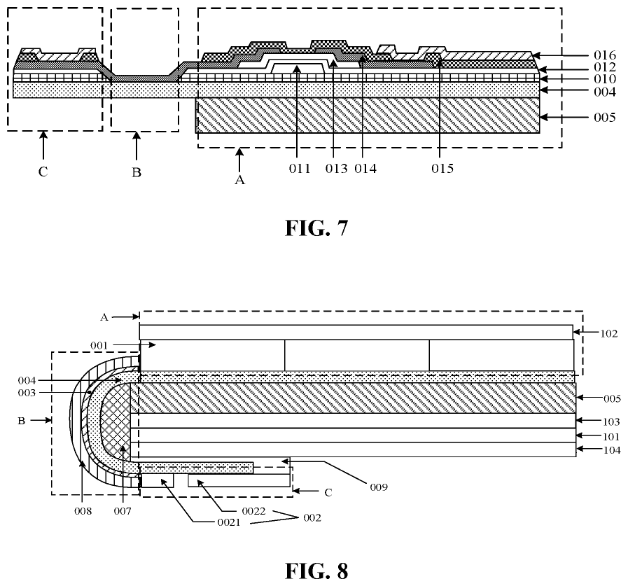

Optionally, with reference to FIG. 7, the liquid crystal display substrate may further include a planarization layer 010. The orthographic projection of the planarization layer 010 on the flexible substrate 004 does not cover the surface of the flexible substrate 004 in the bending region B, and the planarization layer 010 may be made of an inorganic material such as silicon oxide, silicon nitride, aluminum oxide or hafnium oxide. The planarization layer 010 is configured to provide a flat surface on the surface of the flexible substrate, for the convenience of subsequent manufacture of film layers.

Moreover, please refer to FIG. 7. The liquid crystal display substrate may further include a gate electrode 011, a gate insulating layer 012, an active layer 013, a source-drain pattern 014, a passivation layer 015 and a pixel electrode 016, etc., which are sequentially laminated on the side, which is away from the flexible substrate 004, of the planarization layer 010. Here, the source-drain pattern 014 serves as the conductive layer 003. The gate electrode 011 may be made of metal such as molybdenum, copper, aluminum and titanium or an alloy, and the gate insulating layer 012 may be made of an inorganic material such as silicon nitride and/or silicon oxide. The active layer 013 may be made of amorphous silicon or a metal-oxide semiconductor material. The source-drain pattern 014 is made of metal such as molybdenum, copper and aluminum or an alloy thereof. The source-drain pattern 014 includes a source electrode, a drain electrode and a data line, and is configured to provide data signals to the TFT. The data line in the bending region B may be directly located on a first side of the flexible substrate 004. The source-drain pattern 014 in the soldering region C is configured to form a soldering pad for binding an IC 0021, a COF 0023, a FPC 0022 and like. Moreover, no brittle inorganic layer such as the buffer layer and the gate insulating layer may be disposed in the soldering region C, so that the source-drain patterns 014 may be prevented from being broken due to the fracture of the inorganic layer during bending. The passivation layer 015 may be made of an inorganic material such as silicon nitride or silicon oxide, and a through hole is disposed in the passivation layer 015. The pixel electrode 016 may be made of indium tin oxide (ITO). The pixel electrode 016 is connected with the source-drain pattern 014 via the through hole in the passivation layer 015, to form the pixel units.

In summary, in the embodiments of the present disclosure, the flexible substrate in the liquid crystal display substrate is in the bent state, such that the driving circuit and the plurality of pixel units are respectively located on two opposite sides of the flexible substrate in the bent state, which can reduce the area occupied by a non-display region in which the driving circuit is located on the display side of the liquid crystal display substrate, and help implementation of a narrow border. In addition, compared with the related art, the driving circuit does not need to be manufactured on the side of the glass substrate, such that driving circuit can be manufactured in a large area, which reduces the difficulty of manufacturing the driving circuit, and increases the yield rate of the driving circuit. Therefore, the present disclosure can facilitate the production of a full-screen LCD and the implementation of an ultra-narrow border splicing screen.

An embodiment of the present disclosure further provides a liquid crystal display device including the liquid crystal display substrate provided in the above embodiments.

Optionally, with reference to FIG. 8, the liquid crystal display device may further include a backlight source 101, an upper polarizer 102 and a lower polarizer 103. The upper polarizer 102 is located on the light emitting side of the pixel unit 001. The lower polarizer 103 and the backlight source 101 are both in the gap formed by the flexile substrate in the soldering region and the flexible substrate 004 in the display region, and the lower polarizer 103 is closer to the pixel unit 001 than the backlight source 001. With continue reference to FIG. 8, when the liquid crystal display substrate include a supporting structure and a third buffer layer 009, and the supporting structure include a first base substrate 005, the lower polarizer 103 is located on the side, which is away from the pixel unit 001, of the first base substrate 005, and the backlight source 101 is located between the lower polarizer 103 and the third buffer layer 009, that is, the backlight source 101 is located on the side, which is away from the first base substrate 005, of the lower polarizer 103. The backlight source 101 is configured to provide backlight to the liquid crystal display substrate.

Further, with reference again to FIG. 8, the liquid crystal display device may further include a middle frame 104 which is on the side, away from the pixel unit 001, of the backlight source 101. The middle frame 104 is configured to fix the backlight source 101 and a liquid crystal cell in the display region A. The middle frame 104 may be made of a material such as metal. In this case, the third buffer layer 009 may fix the flexible substrate 004 in the soldering region C to the side, which is away from the backlight source 101, of the middle frame 104.

Moreover, when the middle frame 104 and the first buffer layer 007 are made of the same material, the middle frame 104 and the first buffer layer 007 may be of an integral structure. On the one hand, the stability of the first buffer layer 007 can be ensured, and on the other hand, the first buffer layer 007 and the middle frame 104 can be formed in one patterning process, so that the manufacturing process of the liquid crystal display device is simplified.

Optionally, the liquid crystal display device further includes a housing (not shown in FIG. 8), which is configured to coat the non-display side of the liquid crystal display substrate and protect the liquid crystal display substrate. In an implementable manner, heat dissipation holes may further be disposed on the housing or a heat dissipation assembly may be further disposed inside the housing for dissipating heat from components in the soldering region C.

The liquid crystal display device may be any product or component with a display function, such as a liquid crystal panel, a piece of electronic paper, a mobile phone, a tablet computer, a television, a display, a notebook computer, a digital photo frame, and a navigator.

In summary, in the embodiments of the present disclosure, the flexible substrate in the liquid crystal display substrate is in a bent state, such that the driving circuit and the plurality of pixel units are respectively located on two opposite sides of the flexible substrate in the bent state, which can reduce the area occupied by a non-display region in which the driving circuit is located on the display side of the liquid crystal display substrate, and help implementation of a narrow border. In addition, compared with the related art, the driving circuit does not need to be manufactured on the side of the glass substrate, such that driving circuit can be manufactured in a large area, which reduces the difficulty of manufacturing the driving circuit, and increases the yield rate of the driving circuit. Therefore, the present disclosure can facilitate the production of a full-screen LCD and the implementation of an ultra-narrow border splicing screen.

The foregoing descriptions are merely exemplary embodiments of the present disclosure, and are not intended to limit the present disclosure. Within the spirit and principles of the disclosure, any modifications, equivalent substitutions, improvements, etc., are within the protection scope of the present disclosure.

What is claimed is:

1. A liquid crystal display substrate, comprising: a plurality of pixel units, a driving circuit, a conductive layer and a flexible substrate, wherein the pixel units are connected with the driving circuit by means of the conductive layer, and the driving circuit is configured to drive the plurality of pixel units to display images;
the flexible substrate is in a bent state, the conductive layer is outside a bending position of the flexible substrate, and the driving circuit and the plurality of pixel units are respectively on two opposite sides of the flexible substrate in the bent state.

2. The liquid crystal display substrate according to claim 1, wherein the conductive layer in a bending region has at least one through hole, a bottom of the through hole is in contact with the flexible substrate, and both the flexible substrate and the conductive layer re bent in the bending region.

3. The liquid crystal display substrate according to claim 2, wherein an extending direction of the through hole is perpendicular to a surface, which is in contact with the bottom of the through hole, of the flexible substrate.

4. The liquid crystal display substrate according to claim 2, wherein a cross section of the through hole is of a circle shape, a diamond shape, or a strip shape, and a direction of the cross section crosses the extending direction of the through hole.

5. The liquid crystal display substrate according to claim 1, further comprising: a first buffer layer, wherein the first buffer layer is on a target surface of a side, which is away from the conductive layer, of the flexible substrate, and covers a portion, which is in the bending region, of the target surface, and the flexible substrate is bent in a bending region.

6. The liquid crystal display substrate according to claim 5, wherein a cross section of a contact surface of the first buffer layer and the flexible substrate in the bending region is of an arc shape in a direction perpendicular to the contact surface.

7. The liquid crystal display substrate according to claim 5, further comprising: a supporting structure, wherein the supporting structure is on the target surface, and an orthographic projection of the supporting structure on the flexible substrate in a first direction covers an orthographic projection of the plurality of pixel units on the flexible substrate in the first direction; and
the first buffer layer covers a surface, which faces the bending region, of the supporting structure.

8. The liquid crystal display substrate according to claim 7, wherein the supporting structure comprises a first base substrate.

9. The liquid crystal display substrate according to claim 5, wherein the first buffer layer is made of metal, foam, resin or acrylic.

10. The liquid crystal display substrate according to claim 1, further comprising: a second buffer layer on a side, which is away from the flexible substrate, of the conductive layer, wherein an orthographic projection of the second buffer layer on the flexible substrate covers an orthographic projection of the conductive layer on the flexible substrate.

11. The liquid crystal display substrate according to claim 10, wherein ductility of a material of the second buffer layer is better than that of a material of the conductive layer.

12. The liquid crystal display substrate according to claim 11, wherein the second buffer layer is made of ultraviolet curing adhesive, acrylic or epoxy resin.

13. The liquid crystal display substrate according to claim 1, further comprising: a third buffer layer, wherein the third buffer layer is inside the bending position of the flexible substrate in the bent state, the third buffer layer is configured to fix a relative position between the flexible substrate in a soldering region and the flexible substrate in a display region;
the driving circuit is formed on a surface of the flexible substrate in the soldering region, and the plurality of pixel units are formed on a surface of the flexible substrate in the display region.

14. The liquid crystal display substrate according to claim 13, further comprising: a supporting structure, wherein a first side of the supporting structure is fixedly connected with a target surface of the flexible substrate in the display region, a second side of the supporting structure is fixedly connected with a first side of the third buffer layer, and a second side of the third buffer layer is fixedly connected with a target surface of the flexible substrate in the soldering region;
wherein an orthographic projection of the supporting structure on the flexible substrate along a first direction covers an orthographic projection of the plurality of pixel units on the flexible substrate along the first direction, the second side of the supporting structure is opposite to the first side of the supporting structure, the second side of the third buffer layer is opposite to the first side of the third buffer layer, and the target surface is, which is away from the conductive layer, of the flexible substrate.

15. The liquid crystal display substrate according to claim 13, further comprising: a first buffer layer, wherein the third buffer layer and the first buffer layer are of an integral structure;
wherein the first buffer layer is on a target surface, which is away from the conductive layer, of the flexible substrate and covers a portion of the target surface in a bending region, and the flexible substrate is bent in the bending region.

16. The liquid crystal display substrate according to claim 13, wherein the third buffer layer is made of foam.

17. The liquid crystal display substrate according to claim 1, further comprising: a second base substrate, wherein an orthographic projection of the second base substrate on the flexible substrate along a second direction covers an orthographic projection of the driving circuit on the flexible substrate along the second direction.

18. A liquid crystal display device, comprising a liquid crystal display substrate;
wherein the liquid crystal display substrate comprises: a plurality of pixel units, a driving circuit, a conductive layer and a flexible substrate, wherein the pixel units are connected with the driving circuit by means of the conductive layer, and the driving circuit is configured to drive the plurality of pixel units to display images;
the flexible substrate is in a bent state, the conductive layer is outside a bending position of the flexible substrate, and the driving circuit and the plurality of pixel units are respectively on two opposite sides of the flexible substrate in the bent state.

19. The liquid crystal display device according to claim 18, wherein a plurality of pixel units of the liquid crystal display substrate comprise liquid crystal cells; and the liquid crystal display device further comprises a middle frame and a backlight source, wherein the backlight source and the middle frame are in a gap formed by the flexible substrate in a soldering region and the flexible substrate in a display region, and the middle frame is on a side, away from the plurality of pixel units, of the backlight source, and the liquid crystal cells and the backlight source are fixedly connected with the middle frame;
the driving circuit is formed on a surface of the flexible substrate in the soldering region, and the plurality of pixel units is formed on a surface of the flexible substrate in the display region.

20. The liquid crystal display device according to claim 19, wherein the liquid crystal display substrate further comprises: a first buffer layer, the first buffer layer is on a target surface of a side, which is away from the conductive layer, of the flexible substrate and covers a portion of the target surface in a bending region, the flexible substrate is bent in the bending region; and
the middle frame and the first buffer layer are of an integral structure.
